(19) United States
(12) Patent Application Publication
(10) Pub. No.: US 2024/0282965 A1
(43) Pub. Date: Aug. 22, 2024

(54) GRAPHITE NEGATIVE ELECTRODE MATERIAL, PREPARATION METHOD THEREFOR AND USE THEREOF

(71) Applicant: NATIONAL INSTITUTE OF CLEAN-AND-LOW-CARBON ENERGY, Beijing (CN)

(72) Inventors: Guanghong PAN, Beijing (CN); Zhijiang SU, Beijing (CN); Wenbin LIANG, Beijing (CN); Chang WEI, Beijing (CN); Quanbin CHEN, Beijing (CN)

(73) Assignee: NATIONAL INSTITUTE OF CLEAN-AND-LOW-CARBON ENERGY, Beijing (CN)

(21) Appl. No.: 18/567,251

(22) PCT Filed: Nov. 29, 2021
(86) PCT No.: PCT/CN2021/133965

§ 371 Date: Dec. 5, 2023

(30) Foreign Application Priority Data
Jun. 10, 2021 (CN) 202110646868.9

(51) Int. Cl. H01M 4/587; C01B 32/205; H01M 10/0525

(52) U.S. Cl. CPC H01M 4/587; C01B 32/205; H01M 10/0525; C01P 2002/60; C01P 2002/74; C01P 2002/78; C01P 2004/04; C01P 2006/40; C01P 2006/80

(57) ABSTRACT

The present invention relates to the field of carbon materials, and discloses a graphite negative electrode material, and a preparation method and application thereof. A crystal size L_{c} in a c-axis direction and a crystal size Lₐ in an a-axis direction, which are obtained by XRD, of the graphite negative electrode material, satisfy the following conditions: 30 nm≤L_{c}≤70 nm formula (I); and 50 nm≤Lₐ≤120 nm formula (II); and a graphitization degree of the graphite negative electrode material satisfies the following condition: 85≤graphitization degree≤93 formula (III). The graphite negative electrode material has high charge-discharge capacity, a high initial coulombic efficiency and excellent rate capability, and the preparation method thereof is simple in process and low in cost.

### CROSS-REFERENCE TO RELATED APPLICATIONS

This application claims the benefit of Chinese Patent Application 202110646868.9 filed on Jun. 10, 2021, the disclosure of which is incorporated herein by reference.

### TECHNICAL FIELD

The present invention relates to the field of carbon materials, and particularly relates to a graphite negative electrode material, and a preparation method and application thereof.

### BACKGROUND

A negative electrode of a lithium ion battery is mainly a carbon material, including amorphous carbon, natural graphite, and artificial graphite. Graphite has a regular layered structure and excellent electrical conductivity, has a theoretical specific capacity of 372 m·h/g, is high in efficiency, and is a mainstream negative electrode material at present. At present, raw materials for developing the artificial graphite mainly include three types: isotropic coke, bituminous adhesive and needle coke. The isotropic coke-based artificial graphite is low in crystallinity, high in isotropy, low in capacity and high in power. The needle coke-based artificial graphite is high in capacity, but relatively poor in rate capability, and the bituminous adhesive is generally between the two.

CN104681786A discloses a coal-based negative electrode material. The coal-based negative electrode material is composed of a coal-based material graphitized inner layer, an intermediate layer, and an outer layer distributed on a surface. A preparation method of the material includes: crushing the coal-based material; adding a binder, or a mixer of a binder and a modifier; and then performing compression and high-temperature graphitization to obtain a finished product.

CN109319757A discloses a method for preparing a negative electrode material of an onion carbon lithium ion battery with a hollow opening. A coal material is used as a raw material and is mixed and heated with a nickel salt or a nickel elementary substance as a catalyst, so that the nickel salt or the nickel elementary substance is evenly distributed on a surface of the coal-based material particle, formed an opening graphite onion carbon layer on the spherical surface after cooling, and finally graphite onion carbon with a hollow opening spherical structure is obtained after acid-base treatment and purification.

CN107528053A discloses a negative electrode material for a lithium ion secondary battery, a negative electrode for a lithium ion secondary battery, and a lithium ion secondary battery. The negative electrode material for the lithium ion secondary battery contains a carbon material, the carbon material has an average interplanar spacing d₀₀₂ as determined by X-ray diffraction of from 0.335 nm to 0.340 nm, a volume average particle size (50% D) of from 1 μm to 40 μm, a maximum particle size Dₘₐₓ of 74 μm or less, and at least two exothermic peaks within a temperature range of from 300° C. to less than 1,000° C. while performing differential thermal analysis in an air flow.

The negative electrode material provided by the above prior art is complex in structure and process and high in cost; moreover, acid, base and the like are adopted for purification treatment in the treatment process, which is not friendly to environment. More importantly, a rate capability of single-phase graphite in the negative electrode material in the prior art is insufficient, which cannot meet actual requirements.

### SUMMARY

In order to overcome the problems of complex structure, insufficient rate capability of single-phase graphite, complex preparation process and high cost of a graphite negative electrode material in the prior art, the present invention provides a coal-based graphite negative electrode material, a preparation method and application thereof. The coal-based graphite negative electrode material has high charge-discharge capacity, high initial coulombic efficiency and excellent rate capability, and the preparation method is simple in process and low in cost.

In order to achieve the above objects, one aspect of the present invention provides a graphite negative electrode material, wherein a crystal size L_{c} in a c-axis direction and a crystal size Lₐ in an a-axis direction, which are obtained by XRD, of the graphite negative electrode material, satisfy the following conditions:

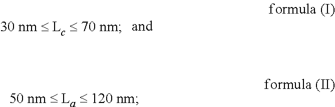

and
a graphitization degree of the graphite negative electrode material satisfies the following condition:

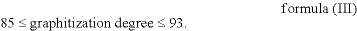

A second aspect of the present invention provides a preparation method of the graphite negative electrode material, wherein the method includes the following steps of:
(1) crushing coal to obtain coal particles; and
(2) graphitizing the coal particles to obtain the graphite negative electrode material;
wherein, the coal meets the following conditions: a vitrinite reflectance greater than or equal to 2; a volatile constituent less than or equal to 10 wt %; and an ash content less than or equal to 10 wt %; and the graphitizing condition includes: controlling an actual maximum supply power of a graphitizing furnace transformer to be greater than or equal to 3,000 kW, and a continuous power transmission time of the actual maximum power transmission power being 1 hour to 100 hours.

A third aspect of the present invention provides a graphite negative electrode material prepared by the preparation method above.

A fourth aspect of the present invention provides an application of the graphite negative electrode material above in at least one of a lithium ion battery, an energy storage material, a mechanical component and a graphite electrode.

According to the above technical solutions, the graphite negative electrode material and the preparation method and application thereof provided by the present invention have the following beneficial effects:
(1) The graphite negative electrode material provided by the present invention has excellent electrochemical performance, and in particular, can significantly improve the rate capability of a battery including the graphite negative electrode material on the premise of maintaining relatively high charge-discharge capacity and initial coulombic efficiency, thereby achieving the best balance of the three, and specifically, the charge-discharge capacity of the graphite negative electrode material is greater than or equal to 330 mAh/g, the initial coulombic efficiency is greater than or equal to 90%, and the capacity retention rate at 2 C/0.2 C is greater than or equal to 35%.
(2) The graphite negative electrode material provided by the present invention has I110/I004 greater than or equal to 0.30, indicating that the graphite negative electrode material has high isotropy, and further, the graphite negative electrode material has a small crystal particle size, thereby further improving the rate capability of the graphite negative electrode material.
(3) The cost of preparing the graphite negative electrode material of the present invention is low, the process is simple and easy to implement, and the raw materials are abundant and easy to obtain.

### DESCRIPTION OF THE DRAWINGS

FIG. 1 is a TEM photograph of a graphite negative electrode material provided in Example 1.

### DESCRIPTION OF EXEMPLARY EMBODIMENTS

The endpoints and any values of the ranges disclosed herein are not limited to the precise ranges or values, which should be understood to include values close to those ranges or values. For numerical ranges, one or more new numerical ranges can be obtained by combining the endpoint values of various ranges, endpoint values of various ranges and individual point values, and individual point values, and these numerical ranges should be regarded as specifically disclosed herein.

A first aspect of the present invention provides a graphite negative electrode material, wherein a crystal size L_{c} in a c-axis direction and a crystal size Lₐ in an a-axis direction, which are obtained by XRD, of the graphite negative electrode material, satisfy the following conditions:

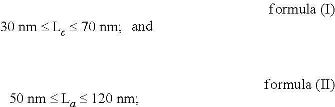

and
a graphitization degree of the graphite negative electrode material satisfies the following condition:

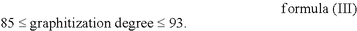

In the present invention, the graphite negative electrode material meeting the above conditions has the characteristics of high isotropy and small crystal particle size, so that lithium ions can be intercalated and desorbed in many channels with short paths, and the rate capability of a battery including the graphite negative electrode material can be significantly improved on the premise of maintaining relatively high charge-discharge capacity and initial coulombic efficiency, thereby achieving the best balance of the three.

In the present invention, the graphite negative electrode material is a coal-based graphite negative electrode material.

In the present invention, a graphitization degree G of the graphite negative electrode material is calculated according to the following formula:

G=(0.344−d₀₀₂)/(0.344−0.3354), wherein d₀₀₂ value is calculated by Bragg equation.

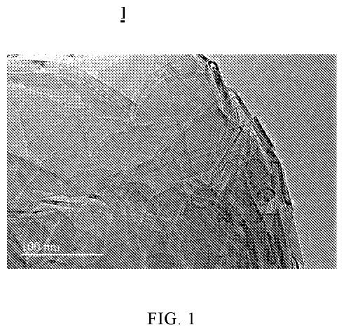

In the present invention, as shown in FIG. 1, the graphite negative electrode material is homogeneous.

Further, when 30 nm≤L_{c}≤50 nm, the rate capability, the charge-discharge capacity and the initial coulombic efficiency of the graphite negative electrode material are further improved.

Further, when 55 nm≤Lₐ≤100 nm, the rate capability, the charge-discharge capacity and the initial coulombic efficiency of the graphite negative electrode material are further improved.

Further, when 86≤graphitization degree≤92, the rate capability, the charge-discharge capacity and the initial coulombic efficiency of the graphite negative electrode material are further improved.

According to the present invention, interplanar spacing d₀₀₂ of a (002) crystal plane, which is obtained by XRD, of the graphite negative electrode material meets the following condition:

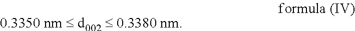

According to the present invention, when the interplanar spacing d₀₀₂ of the (002) crystal plane meets that 0.3360 nm≤d₀₀₂≤0.3370 nm, the graphite negative electrode material has more excellent comprehensive performance.

According to the present invention, a peak intensity I110 of a (110) crystal plane and a peak intensity I004 of a (004) crystal plane, which are obtained by XRD, of the graphite negative electrode material, meet the following condition:

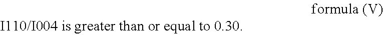

In the present invention, the isotropy of the graphite negative electrode material meeting the above conditions is further increased, such that the rate capability of the graphite negative electrode material is further improved.

Further, when 0.35≤I110/I004≤0.85, the graphite negative electrode material has more excellent rate capability.

According to the present invention, an ash content of the graphite negative electrode material is less than or equal to 1000 ppm.

In the present invention, the ash content of graphite negative electrode material is measured by the method in GB/T3521. The graphite negative electrode material provided by the present invention has low ash content, which can significantly improve the overall homogeneity of the graphite negative electrode material.

Further, the ash content of the graphite negative electrode material is less than or equal to 500 ppm.

A second aspect of the present invention provides a preparation method of a graphite negative electrode material, wherein the method includes the following steps of:
(1) crushing coal to obtain coal particles; and
(2) graphitizing the coal particles to obtain the graphite negative electrode material;
wherein, the coal meets the following conditions: a vitrinite reflectance greater than or equal to 2; a volatile constituent less than or equal to 10 wt %; and an ash content less than or equal to 10 wt %; and the graphitizing condition includes: controlling an actual maximum supply power of a graphitizing furnace transformer to be greater than or equal to 3000 kW, and a continuous power transmission time of the actual maximum power transmission power being 1 hour to 100 hours.

In the present invention, the graphitizing device may be a graphitizing device commonly used in industry in the art, and specifically, the graphitizing device may be selected from at least one of an Acheson furnace, a box-type furnace, an inner-series furnace, a vertical graphitizing furnace, and a horizontal graphitizing furnace.

According to the present invention, the coal is used as the raw material to develop the graphite negative electrode material having low cost and unique micro-nano structure, and when the graphite negative electrode material is prepared according to the method provided by the present invention, high additional value utilization as well as clean and efficient conversion of the coal can be achieved.

In the present invention, when the coal meeting the above conditions is selected as the raw material for preparing the graphite negative electrode material, the prepared graphite negative electrode material has a moderate graphitization degree, and has the characteristics of small crystal particle size and high isotropy, thereby significantly improving the rate capability, the charge-discharge capacity, and the initial coulombic efficiency of the graphite negative electrode material.

In the present invention, a vitrinite reflectance of the coal is measured by method GB/T 6948 in the national standard, and the volatile constituent content and the ash content of the coal are both measured by method GB/T 30732 in the national standard.

According to the present invention, the coal meets the following conditions: a vitrinite reflectance greater than or equal to 2.35; a volatile constituent less than or equal to 10 wt %; and an ash content less than or equal to 6 wt %.

In the present invention, a conventional device in the art, such as a jet mill, may be used to crush the coal.

According to the present invention, in step (1), a particle size D₅₀ of the coal particles is 1 μm to 100 μm, preferably 5 μm to 30 μm.

According to the present invention, the method further includes a step of shaping and/or grading the coal particles.

According to the present invention, step (2) includes the following steps of:
(2-1) carbonizing the coal particles to obtain an intermediate; and
(2-2) graphitizing the intermediate to obtain the graphite negative electrode material.

In the present invention, before the graphitizing treatment, carbonizing the coal particles can remove the volatile constituents or ash in the coal particles to avoid agglomeration caused by escape of the volatile constituents or ash in the graphitizing process; meanwhile, the graphitization degree of the product can be improved, such that the charge-discharge capacity and the initial coulombic efficiency of a battery including the graphite negative electrode material are higher, and therefore the best balance of the capacity, the efficiency and the rate capacity is achieved.

According to the present invention, in step (2-1), the carbonizing condition includes: a carbonizing temperature of 400° C. to 1,800° C., and a carbonizing time of 1 hour to 10 hours.

In the present invention, the carbonizing is performed in the presence of an inert atmosphere.

According to the present invention, in step (2), the graphitizing condition includes: controlling an actual maximum supply power of a transformer in a graphitizing device to be 5,000 kW to 50,000 kW, and a continuous power transmission time of the actual maximum power transmission power being 5 hours to 50 hours.

Further, the graphitizing condition includes: controlling the actual maximum supply power of the transformer in the graphitizing device 10,000 kW to 30,000 kW, and the continuous power transmission time of the actual maximum power transmission power being 8 hours to 40 hours.

A third aspect of the present invention provides a graphite negative electrode material prepared by the preparation method above.

A fourth aspect of the present invention provides an application of the graphite negative electrode material above in at least one of a lithium ion battery, an energy storage material, a mechanical component and a graphite electrode.

In the present invention, the lithium ion battery including the graphite negative electrode material above has excellent electrochemical performance, and specifically, the lithium ion battery including the graphite negative electrode material above has charge-discharge capacity greater than or equal to 330 mAh/g, initial coulombic efficiency greater than equal to 90%, and capacity retention rate at 2 C/0.2 C greater than equal to 35%.

The present invention is described in detail hereinafter with reference to the embodiments.
(1) XRD analysis

### XRD Analysis of Graphite Negative Electrode Material

Interplanar spacing d₀₀₂, Lₐ, L_{c}, and I110/I004 were all tested and analyzed by a D8 Advance type X-ray diffractometer of Bruker AXS GmbH. XRD was calibrated by means of a silicon internal standard method, d₀₀₂ value was calculated by Bragg equation 2d sin Θ₀₀₂=nλ, and Lₐ and L_{c} were calculated by Scherrer equation.
(2) particle size (D₁₀, D₅₀, D₉₀)

D₅₀ was obtained by a Malvern Mastersizer 2000 laser particle size meter of Malvern Instruments Ltd.
(3) A morphology of the graphite negative electrode material was characterized by a Transmission Electron Microscope (TEM):
the TEM photograph was obtained by testing via an ARM200F transmission electron microscope of JEOL Company.
(4) Battery performance

The charge-discharge capacity and the initial coulombic efficiency of the battery were subjected to charge-discharge tests through a CT2001A battery tester of a battery test system of Wuhan Land Electronics Co., Ltd. at a current of 0.1 C (1 C=350 mAh/g) and a voltage of 0 V to 3 V.
(5) A vitrinite reflectance of coal was measured by method GB/T 6948 in the national standard, and a volatile constituent content and an ash content of the coal were both measured by method GB/T 30732 in the national standard.

### Example 1

(1) Coal (vitrinite reflectance of 2.445; volatile content of 7.7 wt %; and ash content of 2.6 wt %) was crushed by a crusher to obtain powder with D₅₀ of 10 μm and then the powder was graded to obtain coal particles;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 20 hours; a graphite negative electrode material was obtained, and was sieved to obtain product A1.

A TEM photograph of the graphite negative electrode material was as shown in FIG. 1. It can be seen from FIG. 1 that product A1 has high isotropy and small crystal particle size.

### Example 2

(1) Coal (vitrinite reflectance of 2.445; volatile content of 7.7 wt %; and ash content of 2.6 wt %) was crushed by a crusher to obtain coal powder with D₅₀ of 10 μm;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 35 hours; a graphite negative electrode material was obtained, and sieved to obtain product A2.

### Example 3

(1) Coal (vitrinite reflectance of 2.445; volatile content of 7.7 wt %; and ash content of 2.6 wt %) was crushed by a crusher to obtain coal powder with D₅₀ of 10 μm;

(2-1) the coal particles were carbonized at 1,000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 10 hours; a graphite negative electrode material was obtained, and sieved to obtain product A3.

### Example 4

(1) Coal (vitrinite reflectance of 2.445; volatile content of 7.7 wt %; and ash content of 2.6 wt %) was crushed by a crusher to obtain coal powder with D₅₀ of 10 μm;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 10,000 kW, and a continuous power transmission time of the actual maximum transmission power was 20 hours; a graphite negative electrode material was obtained, and sieved to obtain product A4.

### Example 5

(1) Coal (vitrinite reflectance of 2.269; volatile content of 6.83 wt %; and ash content of 9.3 wt %) was crushed by a crusher to obtain powder with D₅₀ of 10 μm and then the powder was graded to obtain coal particles;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 20 hours; a graphite negative electrode material was obtained, and sieved to obtain product A5.

### Example 6

(1) Coal (vitrinite reflectance of 2.269; volatile content of 6.83 wt %; and ash content of 9.3 wt %) was crushed by a crusher to obtain powder with D₅₀ of 10 μm and then the powder was graded to obtain coal particles;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 5,000 kW, and a continuous power transmission time of the actual maximum transmission power was 20 hours; a graphite negative electrode material was obtained, and sieved to obtain product A6.

### Example 7

(1) Coal (vitrinite reflectance of 2.269; volatile content of 6.83 wt %; and ash content of 9.3 wt %) was crushed by a crusher to obtain powder with D₅₀ of 10 μm and then the powder was graded to obtain coal particles;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 5 hours; a graphite negative electrode material was obtained, and sieved to obtain product A7.

### Example 8

A graphite negative electrode material was prepared according to the method of Example 1, except that in the step (2-1), the carbonizing condition was different from that in Example 1. Specifically, the carbonizing temperature was 400° C., and the time was 0.5 hour.

### Example 9

A graphite negative electrode material was prepared according to the method of Example 1, except that in the step (2-1), the carbonizing condition was different from that in Example 1. Specifically, the carbonizing temperature was 2200° C., and the time was 15 hours.

### Example 10

(1) Coal (vitrinite reflectance of 2.445; volatile content of 7.7 wt %; and ash content of 2.6 wt %) was crushed by a crusher to obtain coal powder with D₅₀ of 10 μm;

(2) the coal particles were graphitized in a graphitizing furnace, wherein in the graphitizing furnace, an actual maximum supply power of a transformer was 22,000 kW, and a continuous power transmission time of the actual maximum transmission power was 20 hours; a graphite negative electrode material was obtained, and sieved to obtain product A10.

### Comparative Example 1

(1) Coal (vitrinite reflectance of 1.947; volatile content of 12.5 wt %; and ash content of 9.4 wt %) was crushed by a jet mill to obtain coal powder with D₅₀ of 10 μm;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 22,000 kW, and a continuous power transmission time of the actual maximum transmission power was 20 hours; a graphite negative electrode material was obtained, and sieved to obtain product D1.

### Comparative Example 2

(1) Coal (vitrinite reflectance of 2.445; volatile content of 7.7 wt %; and ash content of 2.6 wt %) was crushed by a jet mill to obtain coal powder with D₅₀ of 10 μm;

(2-1) the coal particles were carbonized at 1000° C. in an inert gas for 2 hours to obtain an intermediate; and

(2-2) the intermediate was graphitized in a graphitizing furnace, wherein in the graphitizing furnace, an actual maximum supply power of a transformer was 600 kW, and a continuous power transmission time of the actual maximum transmission power was 20 hours; a graphite negative electrode material was obtained, and sieved to obtain product D2.

### Comparative Example 3

A negative electrode material was prepared according to the method of Example 1, except that the coal was replaced by pitch coke. Negative electrode material D3 was prepared.

The graphite negative electrode materials prepared in the examples and the comparative examples were characterized, and the results can be seen in Table 1 below.

TABLE 1

| | Ash | Graphitization | | | | |
|---|---|---|---|---|---|---|
| Example | content/ppm | degree | d₀₀₂/nm | L_{c}/nm | Lₐ/nm | I110/I004 |
| Example 1 | 257 | 91.4% | 0.33614 | 44.6 | 93.7 | 0.806 |
| Example 2 | 183 | 91.5% | 0.33613 | 41.8 | 94.1 | 0.801 |
| Example 3 | 223 | 90.3% | 0.33623 | 44.8 | 92.3 | 0.497 |
| Example 4 | 268 | 90.0% | 0.33626 | 43.4 | 95.7 | 0.487 |
| Example 5 | 487 | 88.8% | 0.33636 | 31 | 103 | 0.357 |
| Example 6 | 326 | 86.3% | 0.33658 | 34.1 | 68 | 0.455 |
| Example 7 | 294 | 87.9% | 0.33644 | 34.1 | 73.6 | 0.412 |
| Example 8 | 265 | 89.9% | 0.33627 | 40.2 | 82.2 | 0.467 |
| Example 9 | 197 | 89.2% | 0.33633 | 34.9 | 73 | 0.481 |
| Example 10 | 287 | 89.1% | 0.33634 | 34.4 | 63.2 | 0.467 |
| Comparative | 398 | 80.2% | 0.33710 | 17.8 | 41.8 | 0.975 |
| Example 1 | | | | | | |
| Comparative | 746 | 82.6% | 0.33690 | 29.8 | 62.6 | 0.418 |
| Example 2 | | | | | | |
| Comparative | 212 | 93.8% | 0.33593 | 61.5 | 158.9 | 0.285 |
| Example 3 | | | | | | |

### Test Example

The negative electrode materials prepared in the examples and the comparative examples were evenly mixed with conductive carbon black Super P and binder poly(vinylidene fluoride) (PVDF) in a mass ratio of 92:3:5, and then added with a solvent N-methyl pyrrolidone (NMP), stirred into a uniform negative electrode slurry, which was evenly coated on an aluminum foil with a scraper, dried to obtain a negative electrode plate, the plate was cut into pieces, and then transferred to an MBraun 2000 glove box (Ar atmosphere, H₂O and O₂ concentration being less than 0.1×10⁻⁶ vol %), and then assembled into a button battery by using a metal lithium plate as a reference electrode. Electrochemical performances of the button battery were tested, and the test results can be seen in Table 2.

TABLE 2

| | Charge-discharge | Initial | Capacity |
|---|---|---|---|
| | capacity at 0.1 | coulombic | retention rate |
| | C/mAh/g | efficiency/% | @2 C/0.2 C/% |
| Example 1 | 353 | 93.9 | 49.3 |
| Example 2 | 354 | 94.4 | 47.1 |
| Example 3 | 347 | 94.2 | 47.2 |
| Example 4 | 345 | 94 | 46.9 |
| Example 5 | 344 | 91.1 | 35.7 |
| Example 6 | 332 | 93.4 | 48.7 |
| Example 7 | 342 | 93.9 | 45.3 |
| Example 8 | 347 | 93.5 | 42.6 |
| Example 9 | 339 | 94.2 | 42.6 |
| Example 10 | 345 | 93.9 | 42 |
| Comparative | 293 | 89.3 | 55 |
| Example 1 | | | |
| Comparative | 336 | 92.9 | 39.8 |
| Example 2 | | | |
| Comparative | 353 | 94.4 | 12 |
| Example 3 | | | |

It can be seen from the results of Table 1 and Table 2 that the charge-discharge capacity and the initial coulombic efficiency of the battery made of the coal-based negative electrode materials prepared in Examples 1-10 of the present invention are better, and the best balance of the charge-discharge capacity, the initial coulombic efficiency and the rate capability of the battery can be achieved.

Those described above are preferred embodiments of the present invention, but the present invention is not limited to the embodiments. Within the scope of the technical concept of the present invention, many simple modifications can be made to the technical solutions of the present invention, including the combination of various technical features in any other suitable way. These simple modifications and combinations shall also be regarded as the contents disclosed by the present invention and belong to the protection scope of the present invention.

1. A graphite negative electrode material, wherein a crystal size L_{c} in a c-axis direction and a crystal size Lₐ in an a-axis direction, which are obtained by XRD, of the graphite negative electrode material, satisfy the following conditions: 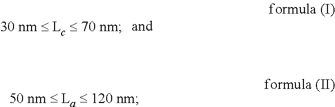
and
a graphitization degree of the graphite negative electrode material satisfies the following condition: 85≤graphitization degree≤93 formula (III).

2. The graphite negative electrode material according to claim 1, wherein 30 nm≤L_{c}≤50 nm.

3. The graphite negative electrode material according to claim 1, wherein 55 nm≤Lₐ≤100 nm.

4. The graphite negative electrode material according to claim 1, wherein 86≤graphitization degree≤92.

5. The graphite negative electrode material according to claim 1, wherein interplanar spacing d₀₀₂ of a (002) crystal plane, which is obtained by XRD, of the graphite negative electrode material meets the following conditions:
0.3350 nm≤d₀₀₂≤0.3380 nm formula (IV); and
preferably, 0.3360 nm≤d₀₀₂≤0.3370 nm.

6. The graphite negative electrode material according to claim 1, wherein a peak intensity a I110 of a (110) crystal plane and a peak intensity I004 of a (004) crystal plane, which are obtained by XRD, of the graphite negative electrode material, meet the following condition:
I110/I004 is greater than or equal to 0.30 formula (V); and
preferably, 0.35≤I110/I004≤0.85.

7. The graphite negative electrode material according to claim 1, wherein an ash content of the graphite negative electrode material is less than or equal to 1000 ppm, and preferably, less than or equal to 500 ppm.

8. A preparation method of a graphite negative electrode material, wherein the method comprises the following steps of:
(1) crushing coal to obtain coal particles; and
(2) graphitizing the coal particles to obtain the graphite negative electrode material;
wherein, the coal meets the following conditions: a vitrinite reflectance greater than or equal to 2; a volatile content less than or equal to 10 wt %; and an ash content less than or equal to 10 wt %; and the graphitizing condition comprises: controlling an actual maximum supply power of a transformer in a graphitizing device to be greater than or equal to 3,000 kW, and a continuous power transmission time of the actual maximum power transmission power being 1 hour to 100 hours.

9. The preparation method according to claim 8, wherein the coal meets the following conditions: a vitrinite reflectance greater than or equal to 2.35; a volatile content less than or equal to 10 wt %; and an ash content less than or equal to 6 wt %.

10. The preparation method according to claim 8, wherein in step (1), a particle size D₅₀ of the coal particles is 1 μm to 100 μm, preferably 5 μm to 30 μm; and
preferably, the method further comprises a step of shaping and/or grading the coal particles.

11. The preparation method according to claim 8, wherein step (2) comprises the following steps of:
(2-1) carbonizing the coal particles to obtain an intermediate; and
(2-2) graphitizing the intermediate to obtain the graphite negative electrode material.

12. The preparation method according to claim 11, wherein in step (2-1), the carbonizing condition comprises: a carbonizing temperature of 400° C. to 1800° C., and a carbonizing time of 1 hour to 10 hours.

13. The preparation method according to claim 8, wherein in step (2), the graphitizing condition comprises: controlling an actual maximum supply power of a transformer in a graphitizing device to be 5,000 kW to 50,000 kW, and a continuous power transmission time of the actual maximum power transmission power being 5 hours to 50 hours; and
preferably, the graphitizing condition comprises: controlling the actual maximum supply power of the transformer in the graphitizing device to be 10,000 kW to 30,000 kW, and the continuous power transmission time of the actual maximum power transmission power being 8 hours to 40 hours.

14. A graphite negative electrode material prepared by the preparation method according to claim 8.

15. A lithium ion battery, comprising the graphite negative electrode material according to claim 1.

16. An energy storage material, comprising the graphite negative electrode material according to claim 1.

17. A mechanical component, comprising the graphite negative electrode material according to claim 1.

18. A graphite electrode, comprising the graphite negative electrode material according to claim 1.
